(19) United States
(12) Patent Application Publication
(10) Pub. No.: US 2019/0279073 A1
(43) Pub. Date: Sep. 12, 2019

(54) Computer Generated Determination of Patentability

(71) Applicant: SAP SE, Walldorf (DE)

(72) Inventor: Sasmito Adibowo, Singapore (SG)

(21) Appl. No.: 15/914,496

(22) Filed: Mar. 7, 2018

(51) Int. Cl. G06N 3/04; G06F 17/30; G06N 3/08; G06Q 50/18

(52) U.S. Cl. CPC G06N 3/0427; G06F 17/30864; G06F 17/30011; G06N 3/0472; G06F 17/22; G06Q 50/184; G06F 17/30345; G06F 2216/11; G06N 3/08

(57) ABSTRACT

Disclosed herein are system, method, and computer program product embodiments for generating a patentability metric and training a patentability model. In an embodiment, a patent analysis system generates and updates a patentability model. The patentability model utilizes vectorized patent publication data and public corpus data to generate a function for predicting the likelihood of patent grant. The patentability model also considers patent grant statistics in generating the function. After generating the function, the patent analysis system may maintain and/or update the patentability model based on new publications and idea disclosures. In this manner, the patent analysis system may analyze vectorized versions of idea disclosures to generate an indicator for predicting patentability.

### BACKGROUND

Companies often encourage their employees to generate new ideas and to innovate. The companies may examine these ideas and determine whether the ideas merit drafting a patent application. To arrive at a determination, companies may research subject matter that has already been disseminated to the public in an attempt to estimate the patentability of an idea. Often, however, companies are unable to adequately search for or categorize public information. Companies often do not have the tools needed to search, refine, and update metrics related to the patentability of patent applications. Further, reviewers of ideas may be barred from searching or reviewing public information. For example, reviewers may be barred from searching for patents or patented ideas, such as idea descriptions associated with patents but not the patent text itself. In these cases, companies may fear patent contamination. This inability to adequately find and/or review public information may hinder a reviewer's ability to estimate a likelihood of patentability for an idea.

### BRIEF DESCRIPTION OF THE DRAWINGS

The accompanying drawings are incorporated herein and form a part of the specification.

FIG. 1 depicts a block diagram of an environment including a patent analysis system, according to some embodiments.

FIG. 2 depicts a block diagram of an environment including a patent analysis system that includes a trainer subsystem, according to some embodiments.

FIG. 3 depicts a flowchart illustrating a method for generating a patentability metric, according to some embodiments.

FIG. 4 depicts a flowchart illustrating a method for training a patentability model, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for using machine learning, artificial intelligence, neural networks, and other computer technology to automatically analyze publically available information and track statuses related to the publically available information. This analysis includes, but is not limited to, generating a patentability metric and training a patentability model.

In an embodiment, a patent analysis system may scrape patent publications and/or other public information to generate a model for predicting patentability. The patent analysis system may also include patentability information related to past idea disclosures from members of an organization or employees of a company. Using computer technology such as artificial intelligence and machine learning, the patent analysis system may generate a function related to resulting patentability determinations of past patent applications. The patent analysis system may generate the patentability model using vectorized text and image information related to the past patent applications. The patent analysis system may then utilize this patentability model and/or apply this model to new idea disclosures or vectorized versions of idea disclosures to predict the patentability of the disclosed idea.

As used herein, the term “idea” includes, for example and without limitation, inventions, concepts, embodiments, methods, creations, discoveries, developments, notions, thoughts, ideas and improvements.

For illustrative purposes, embodiments are described in the context of patents and patentability. However, this disclosure is not so limited. For example, embodiments of the disclosure may be utilized to generate information models corresponding to publically available information for the purpose of more quickly generating status metrics related to the public information.

In an embodiment, a company or organization may utilize the patent analysis system to evaluate new idea disclosures submitted by employees. The patent analysis system may convert the text and/or image data of a new idea disclosure into a vectorized form. The patent analysis system may then apply a patentability model to the vectorized idea disclosure to generate a patentability metric. The patentability metric may be a measure of patentability relative to the vectorized data used to generate the patentability model.

The patent analysis system may utilize computer technology to implement a training process to generate the patentability model using data from patent publications (such as, for example, patents and/or published patent applications), scholarly articles and/or papers available to the public, and/or private idea disclosure data, to name just some examples. In an embodiment, the private idea disclosure data may be idea disclosures and/or patent applications filed by a company or organization utilizing the patent analysis system. Via a computer implemented model training process, the patent analysis system may identify subject matter that is already available to the public. In an embodiment, the model training process may identify subject matter that may have been filed in a patent application but may have been abandoned during the prosecution process. In an embodiment, the model training process may identify subject matter that became patented and/or distinguish this patentable subject matter from subject matter that was abandoned. In an embodiment, the patent analysis system may compare patented claims against subject matter described in the specification of a patent to determine the scope of the patented claim. This comparison may generate a patentability metric indicative of a potential claim scope that may be obtained from a new idea disclosure.

Via the computer implemented processes of training the patentability model based on patent grant statistics and analyzing new idea disclosures according to the patentability model, the patent analysis system is configured to automatically generate an estimation of the patentability of new ideas. By utilizing vectorized forms of public information and patent application data and machine learning to create a base patentability model, the patent analysis system allows computers to utilize less computer hardware and software resources when evaluating new disclosures. Relative to conventional information evaluation methods, computers are able to utilize less system resources because the processes of scraping and evaluating large bodies of information need not occur each time a new idea disclosure is evaluated. Computer system have pre-evaluated this data in the generation of the patentability model.

The patent analysis system may allow for an objective evaluation of new idea disclosures as well as increasing the breadth of review of published information. In this manner, the patent analysis system may generate an analysis without human search or analysis of existing publications. The particular processes described may yield a faster evaluation of new idea disclosures due to fewer processing steps needed to evaluate existing public information. The utilization of a patentability may provide increased processing speeds when evaluating new ideas and may utilize fewer computer resources during the evaluation.

Additionally, the patentability model embodiments described herein operate in an innovative manner and yield better results when compared to conventional manual approaches to evaluating idea disclosures. For example, via the machine learning techniques described herein as well as the patentability statistics gathered, application of the patentability model to new idea disclosures yields a more accurate and objective evaluation of the patentability of a new idea disclosure. For example, by generating a patentability model over time via the scraping of public information and patent publication information, computers need not truncate their analysis of publications when evaluating new ideas. In this manner, the patent analysis system described herein is able to more accurately capture the state of the art because the patent analysis system continuously develops its patentability model. This continuously changing patentability model will then more accurately generate a patentability metric when applied to new idea disclosures.

These features will now be discussed with respect to the corresponding figures.

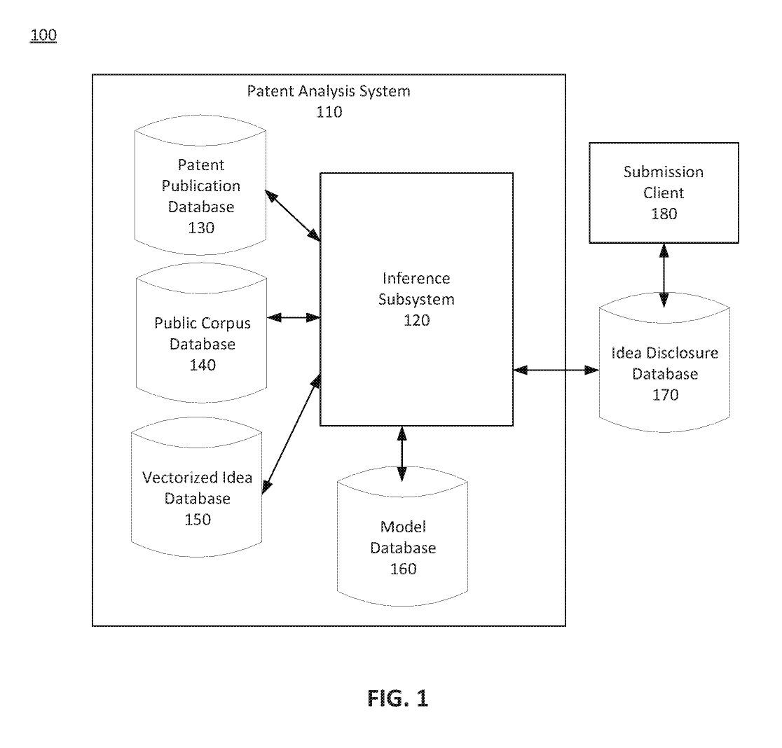

FIG. 1 depicts a block diagram of an environment 100 including a patent analysis system 110, according to some embodiments. In an embodiment, patent analysis system 110 receives idea disclosures and generates a patentability metric for the received idea disclosure. The patentability metric may be a numerical value, percentage, score, letter grade, and/or other indicator of patentability related to the received idea disclosure. To generate this patentability metric, patent analysis system 110 may utilize a patentability model.

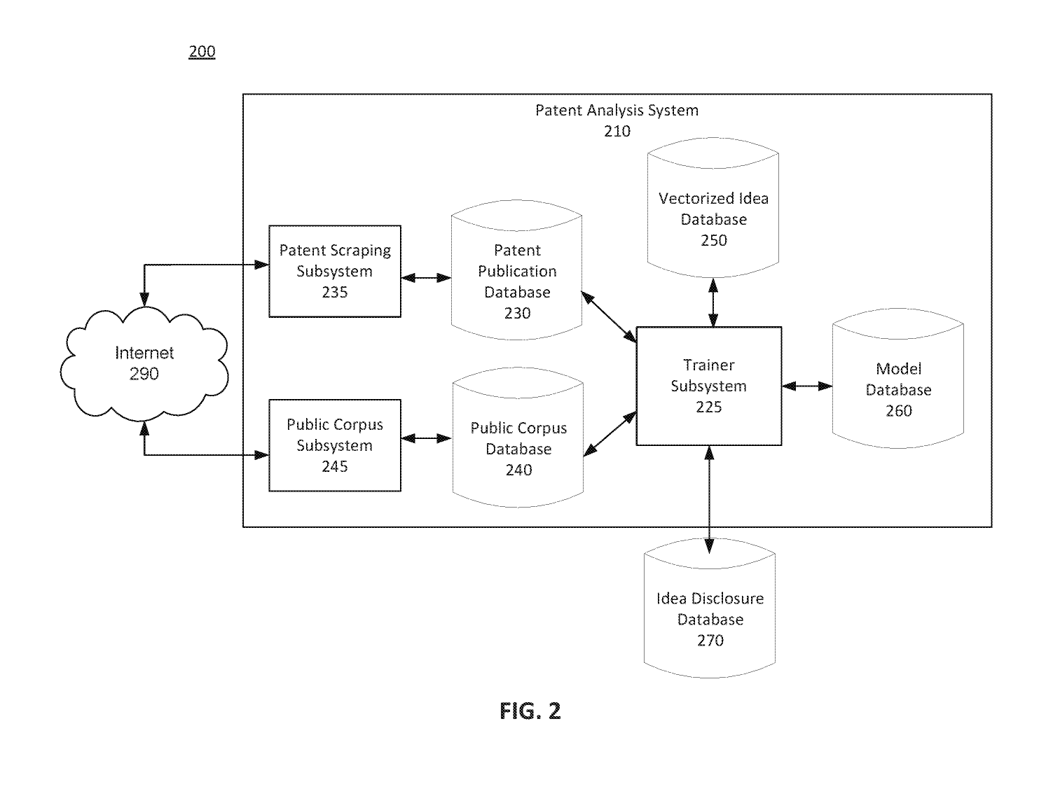

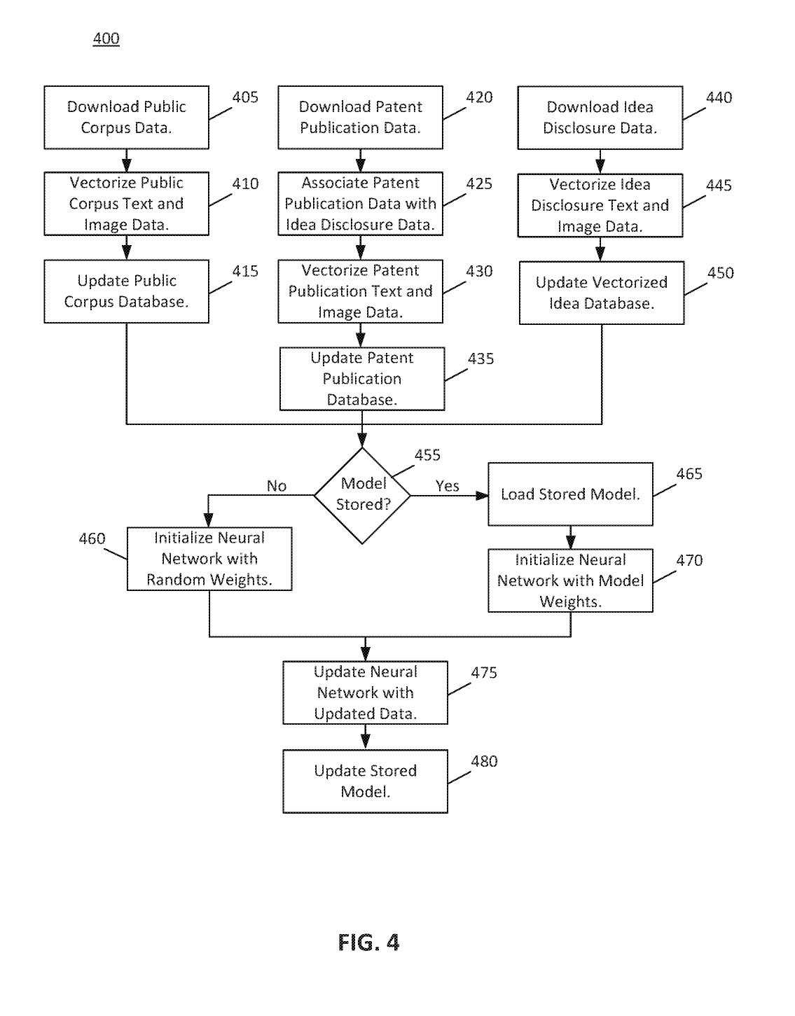

In an embodiment, the patentability model may be a function to be applied to vectorized idea disclosures. Patent analysis system 110 may collect information related to patent publications, public corpus information such as scholarly articles, press releases, and/or other subject matter available publically via the Internet, and/or may internally maintain information related to previously submitted idea disclosures, to name just some examples. Using this collection of data, patent analysis system 110 may train a patentability model to be applied to new idea disclosures. FIG. 2 depicts an embodiment of patent analysis system 210 that trains a patentability model and FIG. 4 depicts an embodiment of a method for training a patentability model.

In an embodiment, training a patentability model includes obtaining patent publication data, public corpus data (e.g., articles, scholarly writings, encyclopedias, text book information, press releases, government agency information, and/or other technological publications), and/or private idea disclosure data, to name just some examples. Using this information, patent analysis system 110 may automatically determine the body of subject matter and ideas that have already been published and/or are publically available. Further, patent analysis system 110 may automatically determine the subject matter and/or ideas that have been patented. For example, patent analysis system 110 may identify published patent applications and determine whether the patent applications were patented or abandoned. Patent analysis system 110 may also track continuing applications related to patent publications. In an embodiment, patent analysis system 110 also tracks decisions related to previously submitted ideas and whether the previously submitted ideas were filed as patent applications. This information allows patent analysis system 110 to identify subject matter and/or idea disclosures that were previously deemed insufficient to file as a patent application.

Utilizing this information, patent analysis system 110 may automatically generate a patentability model related to the body of existing information. This patentability model may be a multivariable function capable of accepting a vectorized idea disclosure (or idea vector) as an input and generating a patentability metric as an output. To generate the patentability model, patent analysis system 110 may utilize computer technology such as machine learning, artificial intelligence, and/or neural networks to analyze the body of publically available information and/or to track the patentability of applications. In an embodiment, the patentability model may weigh different variables in determining a patentability metric. For example, if an idea disclosure includes words, phrases, sentences, paragraphs, and/or images that are similar to subject matter disclosed in past publications, the patentability model may yield a lower patentability metric indicating that the idea disclosure may have a low likelihood of patentability.

In weighing this consideration, however, the patentability model may also identify improvements to the prior art based on the grant of patents and patent grant statistics. For example, while recognizing the subject matter of past patent publications, patent analysis system 110 may further measure the patentability of the subject matter and/or may parse the subject matter deemed patentable by a patent granting government agency. In this manner, patent analysis system 110 may generate a baseline representation of the “state of the art” or the latest improvements to a technology area. Patent analysis system 110 may then compare vectorized idea disclosures to this baseline via an application of the patentability model to the vectorized idea disclosure to determine the likelihood that the idea represents an improvement to the state of the art. In an embodiment, through this analysis, patent analysis system 110 may generate a patentability metric, such as, for example, a confidence score or a percentage probability that the idea disclosure may result in the grant of a patent. The description with reference to FIG. 4 further describes an embodiment of training a patentability model.

After the generation of a patentability model, patent analysis system 110 may utilize the patentability model to evaluate received idea disclosures. In an embodiment, submission client 180 may submit an idea disclosure to idea disclosure database 170. Submission client 180 may be a computing device, such as, for example, a desktop computer, a laptop computer, a mobile phone, a tablet device, and/or other computing devices capable of word processing and/or image generation. In an embodiment, submission client 180 may be an Internet browser and/or a graphical user interface capable of receiving text and/or image data. Using submission client 180, users may formulate idea disclosures and/or submit files containing idea disclosures to idea disclosure database 170 and/or patent analysis system 110.

In an embodiment, submission client 180 may communicate with idea disclosure database 170 and/or patent analysis system 110 via a network and/or a network protocol. The network may be capable of transmitting information either in a wired or wireless manner and may be, for example, the Internet, a Local Area Network (LAN), or a Wide Area Network (WAN). The network protocol may be, for example, a hypertext transfer protocol (HTTP), a TCP/IP protocol, User Datagram Protocol (UDP), Ethernet, cellular, Bluetooth, or an asynchronous transfer mode, and/or a combination of the listed protocols.

In an embodiment, submission client 180 may be a user device and idea disclosure database 170 may be a centralized database controlled and/or managed by a company or organization. In an embodiment, idea disclosure database 170 may aggregate idea disclosures and/or may serve as a buffer for idea disclosures between patent analysis system 110 and one or more submission clients 180. In an embodiment, idea disclosure database 170 may store text and/or image files and/or data associated with idea disclosures. In an embodiment, idea disclosure database 170 may store personal inventor and/or employee information related to the one or more individuals that have conceptualized the idea disclosure. This information may include names, addresses, dates of conception, and/or other information related to the idea disclosure.

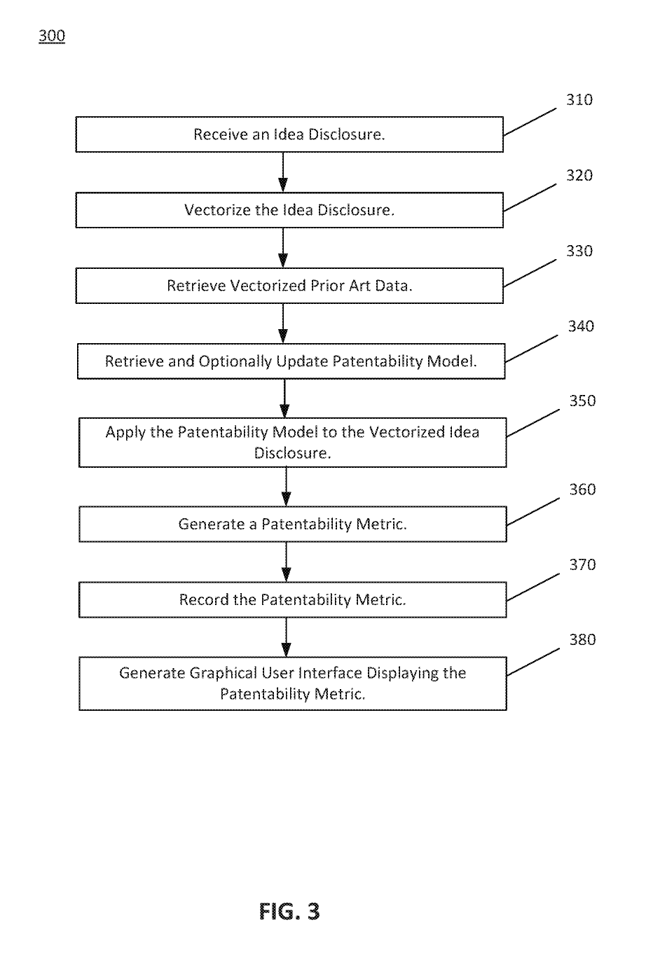

In an embodiment, for patent analysis system 110 to begin an analysis of an idea disclosure, patent analysis system 110 may receive an idea disclosure from submission client 180 and/or retrieve an idea disclosure from idea disclosure database 170. The idea disclosure may be an object and/or one or more text and/or image files organized into an idea disclosure data object. Inference subsystem 120 may receive and/or retrieve the idea disclosure. Inference subsystem 120 may include one or more processors, memory, servers, routers, modems, and/or antennae configured to receive and/or retrieve idea disclosures, retrieve patentability models, and/or apply a patentability model to an idea disclosure to generate a patentability metric associated with the idea disclosure. The discussion with respect to FIG. 3 describes an embodiment of a method for generating a patentability metric.

In an embodiment, inference subsystem 120 may retrieve a patentability model from model database 160. The patentability model may be a computer implemented model that has been trained to generate a function that accepts vectorized idea disclosures or idea vectors. In an embodiment, inference subsystem 120 may vectorize a received idea disclosure including text and/or image data. Inference subsystem 120 may utilize algorithms such as, but not limited to, Word2vec or fastText to generate vectorized representations of the idea disclosure. Inference subsystem 120 may additionally generate word associations such as synonyms that may also be vectorized. In an embodiment, the vectorization process may generate a vector space with multiple dimensions as a representation of the idea disclosure. In an embodiment, inference subsystem 120 may convert images into shapes and/or text and may vectorize the text or shapes. In an embodiment, inference subsystem 120 may utilize optical character recognition to extract text from images.

After converting the idea disclosure into a vector format, inference subsystem 120 may retrieve the patentability model from model database 160 and/or other past publication information. For example, inference subsystem 120 may retrieve patent publication data, including patents and/or published patent applications from patent publication database 130. In an embodiment, inference subsystem 120 may retrieve stored public corpus data from public corpus database 140. Public corpus data may include articles, scholarly writings, encyclopedias, text book information, press releases, government agency information, and/or other technological publications, to name just some examples. In an embodiment, inference subsystem 120 may query patent publication database 130 and/or public corpus database 140 when generating a patentability metric to determine whether new patent publication information or public corpus information has been fetched since the last time the patentability model has been updated and/or trained.

For example, patent analysis system 110 may schedule to scrape Internet resources for updated patent and/or public corpus data once each hour. Patent analysis system 110, however, may update the patentability model stored in model database 160 twice per day. (It is noted that the time intervals discussed herein are provided for illustrative purposes only, and that other time intervals may be alternatively used.) In this case, if a user submits an idea disclosure to patent analysis system 110 before the patentability model has been updated, patent analysis system 110 may fetch updated data stored in patent publication database 130 and/or public corpus database 140 to update the patentability model as it applies to submitted idea disclosure. In an embodiment, patent publication database 130 and/or public corpus database 140 may be updated by one or more processors and/or a subsystem separate from inference subsystem 120. In this manner, inference subsystem 120 may generate a patentability metric while information resources may be maintained by another subsystem, such as, for example trainer subsystem 225 as described with reference to FIG. 2. This configuration may allow for less computer resource usage and requirements when evaluating new idea disclosures because inference subsystem 120 may be able to offload the analysis of information resources to trainer subsystem 225. In this manner, inference subsystem 120 may be able to more quickly evaluate an idea disclosure relative to systems that gather information each time a new idea disclosure is received, while at the same time reducing the amount of computing resources needed to perform such functionality.

In an embodiment, inference subsystem 120 may access vectorized idea database 150 in a similar manner to update the patentability model to be applied to the idea disclosure. Vectorized idea database 150 may include a record of idea disclosures that have been previously submitted to patent analysis system 110. In an embodiment, vectorized idea database 150 may mirror and/or store data similar to the data stored in idea disclosure database 170. In an embodiment, vectorized idea database 150 may store the idea disclosure objects in a vectorized form. The vectorized objects may be reorganized in a manner that differs from idea disclosure database 170 to categorize objects in terms of subject matter rather than as self-contained objects representing separate idea disclosures.

In an embodiment, a subsystem of patent analysis system 110 may update vectorized idea database 150 with resulting patentability determinations of previously tracked patent applications. For example, a first idea disclosure may be vectorized and stored in vectorized idea database 150. After drafting the patent application and submitting the application, a patent agency may determine that the subject matter of the first idea disclosure is an improvement to the art and may grant a patent covering the subject matter. Patent analysis system 110 may periodically scrape and/or query patent information websites to determine if a patent has been allowed or abandoned. When patent analysis system 110 identifies that a tracked patent application has reached a determination, patent analysis system 110 may update vectorized idea database 150. Inference subsystem 120 may then utilize this disposition to update the patentability model when determining a patentability metric for an idea disclosure. Inference subsystem 120 may optionally update the patentability model and store the updated model in model database 160.

After determining whether to update the patentability model based on the presence of updated data in patent publication database 130, public corpus database 140, and/or vectorized idea database 150, inference subsystem 120 may apply the patentability model to the vectorized idea disclosure. The application of the patentability model to the vectorized idea disclosure may then yield a patentability metric such as, for example, a percentage representative of the likelihood of patentability. In an embodiment, the patentability model may be based on patterns determined based on previously granted patents. Patent analysis system 110 may then generate a graphical user interface displaying the patentability metric and/or transmit the patentability metric to submission client 180 to be displayed.

FIG. 2 depicts a block diagram of an environment 200 including a patent analysis system 210 that includes a trainer subsystem 225, according to some embodiments. Patent analysis system 210 may operate in a manner similar to patent analysis system 110 and/or may include a subsystem similar to inference subsystem 120. Patent publication database 230 may operate in a manner similar to patent publication database 130. Public corpus database 240 may operate in a manner similar to public corpus database 140. Vectorized idea database 250 may operate in a manner similar to vectorized idea database 150. Model database 260 may operate in a manner similar to model database 160. Idea disclosure database 270 may operate in a manner similar to idea disclosure database 170. In an embodiment, patent analysis system 210 includes trainer subsystem 225 and depicts an embodiment of a system that generates a patentability model.

Trainer subsystem 225 may include one or more processors and/or circuitry configured to generate a patentability model and/or update a patentability model based on updated patent publication information, public corpus information, and/or resulting patentability determinations of previous idea disclosures.

In an embodiment, patent scraping subsystem 235 retrieves updated patent publication information from the Internet 290. For example, patent scraping subsystem 235 may utilize a list of websites and/or a list of patent or patent application numbers to scrape patent publication information. In an embodiment, patent scraping subsystem 235 may query government agency websites to obtain new publication information. This querying may occur periodically. Patent scraping subsystem 235 may also vary in breadth of subject matter scraped. For example, patent scraping subsystem 235 may identify patent publications related to specific technology areas. In an embodiment, patent scraping subsystem 235 may generate a larger breadth and/or scrape patent publications without a specific regard for technology area.

In an embodiment, patent scraping subsystem 235 may operate on a schedule and/or scrape different technology areas at different times. For example, patent scraping subsystem 235 may query different agency art units according to a schedule rather than querying every art unit at each periodic interval. In this manner, the processing load on patent scraping subsystem 235 may be eased. Similarly, in an embodiment, patent scraping subsystem 235 may form an initial baseline capture of the state of the art but may then subsequently retrieve new patent applications publications and/or notices of patent grants. In this manner, patent scraping subsystem 235 may again reduce the processing load by focusing on new publications rather than constantly rechecking past publications.

In an embodiment, after retrieving a new patent application publication, patent scraping subsystem 235 may vectorize the patent application publication and/or store the vectorized data in patent publication database 230. In an embodiment, patent scraping subsystem 235 may store the patent application publication as an object and/or a file in patent publication database 230. Trainer subsystem 225 may then perform the vectorization process when generating or updating a patentability model.

In addition to retrieving patent application publication information, patent scraping subsystem 235 may also query status information related to idea disclosures stored in vectorized idea database 250. For example, if a patent application has been filed that corresponds to an idea disclosure stored in vectorized idea database 20, patent scraping subsystem 235 may query an agency website to determine whether a final determination has occurred regarding the patent application. For example, patent scraping subsystem 235 may determine if a patent has been granted or if the application has been abandoned. In an embodiment, patent scraping subsystem 235 may analyze the number of rejections received and/or the claim language that was allowed or rejected. Trainer subsystem 225 may utilize the vectorization of this claim language to generate the patentability model.

Similar to the scraping process of patent scraping subsystem 235, public corpus subsystem 245 retrieves updated public corpus information from the Internet 290. Public corpus subsystem 245 may query certain websites and/or may subscribe to receive content from various websites. Public corpus subsystem 245 may subscribe to publications and/or may be notified of new articles, scholarly writings, encyclopedias, text book information, press releases, government agency information, and/or other technological publications. In an embodiment, public corpus subsystem 245 may crawl publications to retrieve new public corpus information. Public corpus subsystem 245 may vectorize this information and/or store the public corpus information in public corpus database 240.

In an embodiment, public corpus subsystem 245 may query different websites and/or publications according to a schedule to reduce processing load. In an embodiment, public corpus subsystem 245 may recognize previously stored public corpus information so that public corpus subsystem 245 need not vectorize and/or analyze publications that have been previously vectorized.

In an embodiment, patent scraping subsystem 235 and/or public corpus subsystem 245 may update the entries of patent publication database 230 or public corpus database 240 independently from the operations of trainer subsystem 225 or inference subsystem 120. In an embodiment, this architecture and separation of operations may allow for specialized processing so that a single processing system need not perform all of the tasks described. This description, however, is not intended to be limiting, and in some embodiments, the various subsystems may be implemented together in various ways.

In an embodiment, when trainer subsystem 225 generates or updates a patentability model and/or when inference subsystem 120 applies a patentability model to a new idea disclosure, patent scraping subsystem 235 and/or public corpus subsystem 245 may query internet resources related to the new idea disclosure. In this manner, while patent analysis system 210 may utilize previously collected data, patent analysis system 210 is still able to determine whether any new data exists that may be relevant to the idea disclosure under evaluation. In an embodiment, inference subsystem 120 may vectorize the idea disclosure under evaluation and pass this vectorized idea disclosure to patent scraping subsystem 235 and/or public corpus subsystem 245 to perform an ad hoc query. By utilizing this ad hoc query in conjunction with previously scraped and vectorized data, patent analysis system 210 may utilize less system resources when evaluating patentability. Patent analysis system 210 need not perform vectorization of large amounts of patent publications and public corpus information each time a new idea disclosure is evaluated. In this manner, because vectorized versions of patent publications and public corpus information have already been stored, patent analysis system 210 is able to more quickly evaluate idea disclosures.

To evaluate an idea disclosure, inference subsystem 120 may utilize a patentability model. Trainer subsystem 225 may generate and/or update this patentability model. FIG. 4 depicts an embodiment of a method for training a patentability model. To train a patentability model, trainer subsystem 225 may utilize information stored in patent publication database 230, public corpus database 240, and/or vectorized idea database 250. Trainer subsystem 225 may vectorize information stored in idea disclosure database 270 and store vectorized idea disclosure information in vectorized idea database 250.

In an embodiment, the model may take the form of a linear regression and/or a machine learning neural network. To train a patentability model, trainer subsystem 225 may generate a regression of granted versus not granted patents. In an embodiment, this regression model may include a multivariable analysis based on the vectorization of the available public data. In an embodiment, trainer subsystem 225 may include statistical information, such as, for example, coefficients of determination or R-squared (R²) values related to the patentability model. Using this model, patent analysis system 210 may generate a value indicative of a prediction of patent grant.

In an embodiment, the patentability model may utilize different curves in multi-dimensional space in order to more accurately model the previously supplied vectorized information. For example, trainer subsystem 225 may utilize a sigmoid function or an activation function to model the vectorized information. In an embodiment, trainer subsystem 225 may determine the function that most closely approximates the vectorized information. After selecting this function, trainer subsystem 225 may train the patentability model by calculating constant values used in the selected function. These constant values may be multiplied against variable values in order to determine an output patentability metric. For example, in cases where a linear regression is used, an example function may take the form of y=mx+b. In this case, the value y may be an output patentability metric and the value x may be an input idea disclosure vector. The values of m and b may be constants. In an embodiment, training the patentability model includes determining the values for m and b based on the previously vectorized data. In an embodiment, if x is a vector or matrix, the value of m may also be a vector or matrix such that when multiplication occurs, the output y may be a numerical value. In this example, the constant b may also be a numerical value.

While the above embodiment describes a single linear example, training the patentability model may include using one or more functions and/or determining one or more constants. Further, multivariable analysis may be utilized depending on the patent publication, public corpus, and past idea disclosure vectors utilized to generate the patentability model. In an embodiment, after trainer subsystem 225 has generated an initial patentability model, trainer subsystem 225 may update the patentability model depending on updated information. In some cases, trainer subsystem 225 may utilize different functions to model the vectorized data. In some cases, trainer subsystem 225 may recalculate constant values used in the functions to more accurately represent the vectorized publication data.

In an embodiment, in addition to, or separate from, the aforementioned approach, trainer subsystem 225 may utilize neural networks and/or a holistic machine learning approach to analyzing the vectorized information. In an embodiment, trainer subsystem 225 may utilize one or more hidden layers. In an embodiment, trainer subsystem 225 may utilize a neural network external to patent analysis system 210 to generate the patentability model. In an embodiment, trainer subsystem 225 may receive a first patentability model and/or may update the received first patentability model according to vector data stored in patent publication database 230, public corpus database 240, and/or vectorized idea database 250. In this case, trainer subsystem 225 may generate a second patentability model.

In an embodiment, trainer subsystem 225 may generate one or more patentability models corresponding to different technology areas. For example, if patent analysis system 210 receives an idea disclosure related to stem cells, trainer subsystem 225 may generate a patentability model specific to stem cell applications. Via the use of the vector format, trainer subsystem 225 may flexibly generate one or more patentability models that vary based on breadth. When utilized, patent analysis system 210 may then provide one or more patentability metrics according to the breadth of disclosures specified and/or different patentability models.

In an embodiment, trainer subsystem 225 may generate and/or update one or more patentability models according to a schedule. In an embodiment, trainer subsystem 225 may generate and/or update one or more patentability models periodically. After the generation or updating of a patentability model, trainer subsystem 225 may store the patentability model in model database 260. Other subsystems, such as, for example, inference subsystem 120 may then access the patentability model when evaluating new idea disclosures. In an embodiment, patent analysis system 210 may export models to be used in system external to patent analysis system 210.

FIG. 3 depicts a flowchart illustrating a method 300 for generating a patentability metric, according to some embodiments. Method 300 shall be described with reference to FIG. 1; however, method 300 is not limited to that example embodiment.

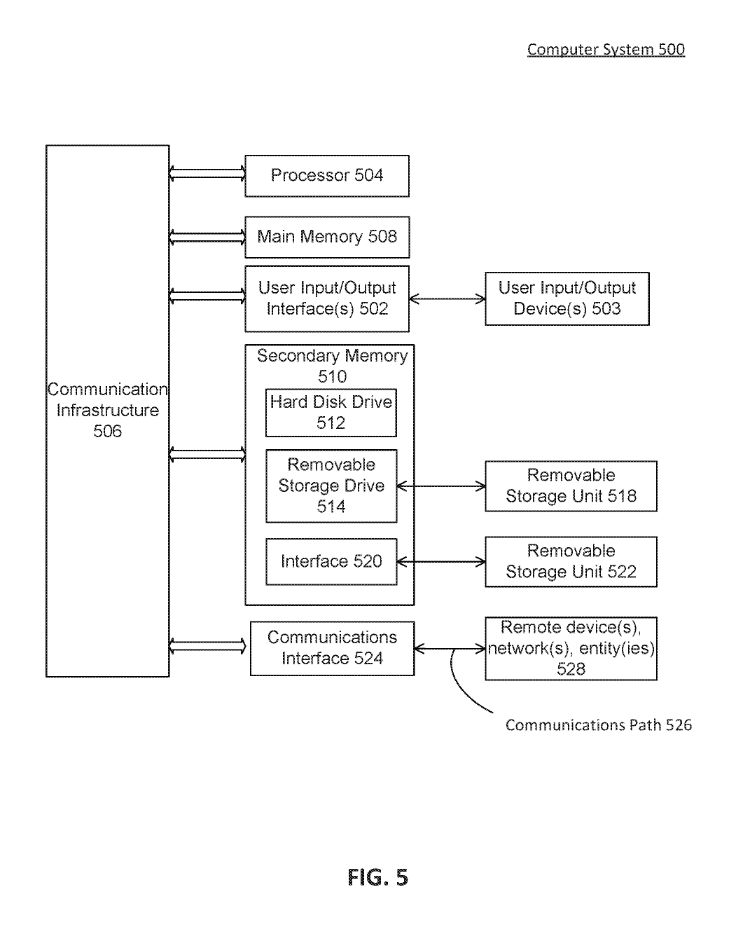

In an embodiment, patent analysis system 110 may utilize method 300 to apply a patentability model to an idea disclosure to generate a patentability metric. The foregoing description will describe an embodiment of the execution of method 300 with respect to patent analysis system 110. While method 300 is described with reference to patent analysis system 110, method 300 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

In an embodiment, at 310, patent analysis system 110 may receive an idea disclosure. The idea disclosure may be an object and/or one or more text and/or image files organized into an idea disclosure data object. Patent analysis system 110 may receive the idea disclosure from a submission client 180 and/or may retrieve the idea disclosure from idea disclosure database 170. In an embodiment, patent analysis system 110 may be a module implemented in a system using various hardware and software components. Patent analysis system 110 may receive the idea disclosure from another module of the system.

At 320, patent analysis system 110 may vectorize the idea disclosure. For example, patent analysis system 110 may utilize vectorization algorithms such as Word2vec or fastText to convert text into vector representations. These vector representations may preserve semantic relationships between words. In an embodiment, these vector representations may include vector spaces with multiple dimensions that may represent the content of the idea disclosure. Patent analysis system 110 may also convert images into vector forms. For example, patent analysis system 110 may recognize certain shapes and/or other image features to determine words associated with an image. Patent analysis system 110 may then convert these words into vectors in a manner similar to the text conversion.

At 330, patent analysis system 110 may retrieve vectorized prior art data. For example, inference subsystem 120 may determine whether patent publication database 130, public corpus database 140, and/or vectorized idea database 150 includes data that has not yet been incorporated or utilized to update a patentability model. In an embodiment, if the databases do not include updated information, patent analysis system 110 may not retrieve vectorized prior art data.

In an embodiment, at 330, patent analysis system 110 may query patent publication resources and/or public corpus resources available via the Internet to determine if new publications are available. If so, patent analysis system 110 may update the patentability model using the new information. In an embodiment, patent analysis system 110 may tailor this query according to the subject of the idea disclosure. In this manner, patent analysis system 110 may maintain a general patentability model but may search for publications relevant to the specific idea disclosure received to determine if the patentability model may be more specifically tailored to the received idea disclosure.

At 340, patent analysis system 110 may retrieve and optionally update a patentability model. For example, inference subsystem 120 may retrieve the patentability model from model database 160. In an embodiment, patent analysis system 110 may retrieve a patentability model from a source external to patent analysis system 110. According to whether new information was discovered at 330, patent analysis system 110 may update and/or modify the patentability model retrieved at 340. This updating may be temporary for the evaluation of the idea disclosure received at 310 and/or may be a permanent update of the patentability model. In the permanent case, patent analysis system 110 may store the updated patentability model in model database 160 and/or may return the updated patentability model to the original source of the original patentability model.

At 350, patent analysis system 110 may apply the patentability model to the vectorized idea disclosure. In an embodiment, the patentability model may be a function capable of accepting one or more vectors or matrices. Patent analysis system 110 may utilize the vectorized idea disclosure as an input to the patentability model. At 360, patent analysis system 110 may calculate the resulting output of the patentability model function to generate a patentability metric. In an embodiment, the patentability metric may be a numerical value, percentage, score, letter grade, and/or other indicator of patentability related to the received idea disclosure.

At 370, patent analysis system 110 may record the patentability metric. For example, patent analysis system 110 may utilize the vectorized idea disclosure and/or the patentability metric to improve and continue to learn. Patent analysis system 110 may utilize this information in evaluations of future idea disclosures. In an embodiment, patent analysis system 110 may store the vectorized idea disclosure in vectorized idea database 150. Patent analysis system 110 may track the progress and/or the final disposition of the vectorized idea disclosure. In an embodiment, patent analysis system 110 may track whether a patent application was actually filed including the idea disclosure. In an embodiment, patent analysis system 110 also tracks whether a patent was granted covering the idea disclosure. Based on at least these two decision points, patent analysis system 110 may continue to train patentability models to aid in predicting the patentability of future idea disclosures.

At 380, patent analysis system 110 may generate a graphical user interface (GUI) displaying the patentability metric. In an embodiment, patent analysis system 110 may instantiate the GUI and/or transmit the GUI to submission client 180. In this manner, a user may view the patentability metric and/or decide whether or not to file a patent application according to the patentability metric. In an embodiment, patent analysis system 110 may return relevant references to submission client 180 based on the vectorized idea disclosure. In an embodiment, patent analysis system 110 may hide patent publications and/or public corpus data from users so that the reviewers may be able to make a patentability determination using the patentability metric and without needing to thoroughly review the underlying references. In this manner, method 300 may be utilized to generate a patentability metric for received idea disclosures.

FIG. 4 depicts a flowchart illustrating a method 400 for training a patentability model, according to some embodiments. Method 400 shall be described with reference to FIG. 2; however, method 400 is not limited to that example embodiment.

In an embodiment, patent analysis system 210 may utilize method 400 to generate and/or update a patentability model. The foregoing description will describe an embodiment of the execution of method 400 with respect to patent analysis system 210. While method 400 is described with reference to patent analysis system 210, method 400 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

In an embodiment, at 405, patent analysis system 210 may download public corpus data. Public corpus data may include articles, scholarly writings, encyclopedias, text book information, press releases, government agency information, and/or other technological publications. In an embodiment, patent analysis system 210 may download public corpus data related to particular subject matter topics and/or according to specific sources of information. For example, patent analysis system 210 may search for resources related to machine learning and/or may search publications by the Institute of Electrical and Electronics Engineers (IEEE). This downloading may occur in response to receiving an idea disclosure and/or may be performed according to a schedule or periodically.

At 410, patent analysis system 210 may vectorize the public corpus data to generate one or more public corpus vectors. Patent analysis system 210 may convert the text and image data into vector and/or matrix formats. In an embodiment, this vectorization may occur in a manner similar to that described with reference to 320. At 415, patent analysis system 210 may update public corpus database 240 with the vectorized public corpus data and/or files representing collected public corpus data. In this manner, public corpus database 240 may be a repository of public corpus data and/or vectorized information for use in generating a patentability model.

At 420, patent analysis system 210 may download patent publication data. Patent publication data may include published patent applications and/or granted patents. In an embodiment, patent analysis system 210 may download patent publication data related to particular subject matter topics and/or newly published patent publications from patent granting agencies. This may occur simultaneously or as a different process from downloading public corpus data at 405.

At 425, patent analysis system 210 may associate the patent publication data with idea disclosure data. For example, patent analysis system 210 may be able to access previous idea disclosure data stored in idea disclosure database 270 and/or vectorized idea database 250. In an embodiment, vectorized idea database 250 may include idea disclosures that have been filed as applications at a patent agency. At 425, based on the patent publication data downloaded at 420, patent analysis system 210 may update status information related to data stored in vectorized idea database 250. Patent analysis system 210 may update a value associated with the idea disclosure object indicating whether an application has been published, granted, abandoned, and/or other information related to the prosecution of the application.

At 430, patent analysis system 210 may vectorize patent publication text and/or image data to generate one or more patent publication vectors. Patent analysis system 210 may convert the text and image data into vector and/or matrix formats. In an embodiment, this vectorization may occur in a manner similar to that described with reference to 320. At 435, patent analysis system 210 may update patent publication database 230 with the vectorized patent publication data and/or files representing collected patent publication data. In this manner, patent publication database 230 may be a repository of patent publication data and/or vectorized information for use in generating a patentability model.

At 440, patent analysis system 210 may download idea disclosure data. Idea disclosure data may include idea disclosures previously submitted to patent analysis system 210. In an embodiment, patent analysis system 210 may retrieve new idea disclosures from idea disclosure database 270 and/or receive new idea disclosures from a session client. This may occur simultaneously or as a different process from downloading public corpus data at 405 and/or downloading patent publication data at 420.

At 445, patent analysis system 210 may vectorize the idea disclosure text and image data to generate one or more idea disclosure vectors. Patent analysis system 210 may convert the text and image data into vector and/or matrix formats. In an embodiment, this vectorization may occur in a manner similar to that described with reference to 320. At 450, patent analysis system 210 may update vectorized idea database 250 with the vectorized idea disclosures and/or files associated with the idea disclosure object. In this manner, vectorized idea database 250 may be a repository of vectorized idea disclosures and/or corresponding patentability outcomes for use in generating a patentability model.

When training a patentability model, at 455, patent analysis system 210 may determine whether a patentability model has been stored in model database 260. Patent analysis system 210 and/or trainer subsystem 225 may query model database 260 to determine whether model database 260 contains a null value or contains data representing a patentability model. In an embodiment, if model database 260, does not include a patentability model, patent analysis system 210 may initialize and generate a new patentability model at 460. If model database 260 includes a model, patent analysis system 210 may update the patentability model at 465 and 470.

At 460, if model database 260 does not include a patentability model, trainer subsystem 225 may initialize a neural network with random weights. For example, trainer subsystem 225 may analyze the collected vector data to determine an appropriate function. Trainer subsystem 225 may additional initialize random constant values for use in the predicted function. This random weighting may act as an initialized starting point for training the patentability model. At 475, trainer subsystem 225 may update the neural network with the updated public corpus data, patent publication data, and/or vectorized idea data. Trainer subsystem 225 may utilize regression analytics to determine the constants yielding a function that most accurately represents the vectorized data. In an embodiment, trainer subsystem 225 may select constants that minimize a coefficient of determination or R-squared value according to the vectorized public corpus, patent publication, and/or idea disclosure data.

At 465, if model database 260 includes a patentability model, trainer subsystem 225 loads the stored model. For example, trainer subsystem 225 may utilize volatile memory and/or one or more processors to perform calculations. At 470, trainer subsystem 225 may initialize a neural network with model weights. These model weights may represent constant values utilized by the patentability model function. At, 475, trainer subsystem 225 may update the neural network with the updated public corpus, patent publication, and/or idea disclosure data. Trainer subsystem 225 may adjust constant values and/or may utilize a different function based on the updated vector information. In an embodiment, trainer subsystem 225 may utilize a function and/or constant values in a manner to achieve best fit to the vectorized data.

At 480, trainer subsystem 225 may store the newly generated and/or updated patentability model. In an embodiment, trainer subsystem 225 may store the patentability model in model database 260. In an embodiment, patent analysis system 210 may export the patentability model to an external system.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518.

Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a memory; and
at least one processor coupled to the memory, the at least one processor configured to:
generate a patentability model, wherein to generate the patentability model, the at least one processor is configured to:
convert text previously submitted as an idea disclosure into a vectorized format to generate one or more idea disclosure vectors;
update a vectorized idea database with the one or more idea disclosure vectors;
download patent publication text data and patent application grant statistics;
associate the one or more idea disclosure vectors with the patent application grant statistics;
convert the patent publication text data into a vectorized format to generate one or more patent publication vectors;
update a patent publication database with the one or more patent publication vectors;
download one or more scholarly articles;
convert text of the one or more scholarly articles into a vectorized format to generate one or more public corpus vectors;
update a public corpus database with the one or more public corpus vectors;
initialize the patentability model with first constant values;
calculate second constant values using the one or more idea disclosure vectors, the patent application grant statistics, the one or more patent publication vectors, the one or more public corpus vectors, and a regression model; and
replace the first constant values of the patentability model with the second constant values;
store the patentability model in the memory;
receive text representative of the idea disclosure; and
in response to receiving the text representative of the idea disclosure:
convert the text into a vectorized format to generate an idea vector;
retrieve the patentability model from the memory; and
apply the patentability model to the idea vector to generate a numerical value indicative of a likelihood of patentability according to the patent application grant statistics.

2. A computer implemented method, comprising:
generating a patentability model using patent application grant statistics, wherein the patentability model generates a numerical value indicative of a likelihood of patentability corresponding to received vectorized text;
receiving text representative of an idea disclosure;
converting the text into a vectorized format to produce a vectorized idea disclosure; and
applying the patentability model to the vectorized idea disclosure to generate a numerical value indicative of the likelihood of patentability according to the patent application grant statistics.

3. The computer implemented method of claim 2, the generating further comprising:
storing a patent application number and a vectorized version of patent application text corresponding to the patent application number;
scraping patent agency website information to determine that an application corresponding to the patent application number has been granted; and
updating the patentability model according to the vectorized version of the patent application text.

4. The computer implemented method of claim 2, the generating further comprising:
downloading a technological publication;
converting text of the technological publication into a vectorized format; and
altering a constant value of the patentability model according to a regression function incorporating the technological publication in the vectorized format.

5. The computer implemented method of claim 2, the generating further comprising:
determining an activation function based on a regression of the patent application grant statistics and vectorized patent application text data; and
determining one or more constant values of the patentability model according to the regression.

6. The computer implemented method of claim 2, further comprising:
in response to the receiving, scraping patent agency website information for a patent publication; and
updating the patentability model to incorporate a vectorized version of the patent publication.

7. The computer implemented method of claim 2, wherein the patentability model includes a neural network.

8. The computer implemented method of claim 2, further comprising:
receiving an image; and
converting the image into a vectorized format to supplement the vectorized idea disclosure.

9. A system, comprising:
a memory; and
at least one processor coupled to the memory, the at least one processor configured to:
generate a patentability model using patent application grant statistics, wherein the patentability model generates a numerical value indicative of a likelihood of patentability corresponding to received vectorized text;
receive text representative of an idea disclosure;
convert the text into a vectorized format to produce a vectorized idea disclosure; and
apply the patentability model to the vectorized idea disclosure to generate a numerical value indicative of the likelihood of patentability according to the patent application grant statistics.

10. The system of claim 9, wherein to generate the patentability model, the at least one processor is further configured to:
store a patent application number and a vectorized version of patent application text corresponding to the patent application number;
scrape patent agency website information to determine that an application corresponding to the patent application number has been granted, and
update the patentability model according to the vectorized version of the patent application text.

11. The system of claim 9, wherein to generate the patentability model, the at least one processor is further configured to:
download a technological publication;
convert text of the technological publication into a vectorized format; and
alter a constant value of the patentability model according to a regression function incorporating the technological publication in the vectorized format.

12. The system of claim 9, wherein to generate the patentability model, the at least one processor is further configured to:
determine an activation function based on a regression of the patent application grant statistics and vectorized patent application text data; and
determine one or more constant values of the patentability model according to the regression.

13. The system of claim 9, wherein the at least one processor is further configured to:
in response to the receiving, scrape patent agency website information for a patent publication; and
update the patentability model to incorporate a vectorized version of the patent publication.

14. The system of claim 9, wherein the patentability model includes a neural network.

15. The system of claim 9, wherein the at least one processor is further configured to:
receive an image; and
convert the image into a vectorized format to supplement the vectorized idea disclosure.

16. A non-transitory computer-readable device having instructions stored thereon that, when executed by at least one computing device, cause the at least one computing device to perform operations comprising:
generating a patentability model using patent application grant statistics, wherein the patentability model generates a numerical value indicative of a likelihood of patentability corresponding to received vectorized text;
receiving text representative of an idea disclosure;
converting the text into a vectorized format to produce a vectorized idea disclosure; and
applying the patentability model to the vectorized idea disclosure to generate a numerical value indicative of a likelihood of patentability according to the patent application grant statistics.

17. The non-transitory computer-readable device of claim 16, wherein to generate the patentability model, the operations further comprise:
storing a patent application number and a vectorized version of patent application text corresponding to the patent application number;
scraping patent agency website information to determine that an application corresponding to the patent application number has been granted; and
updating the patentability model according to the vectorized version of the patent application text.

18. The non-transitory computer-readable device of claim 16, wherein to generate the patentability model, the operations further comprise:
downloading a technological publication;
converting text of the technological publication into a vectorized format; and
altering a constant value of the patentability model according to a regression function incorporating the technological publication in the vectorized format.

19. The non-transitory computer-readable device of claim 16, wherein to generate the patentability model, the operations further comprise:
determining an activation function based on a regression of the patent application grant statistics and vectorized patent application text data; and
determining one or more constant values of the patentability model according to the regression.

20. The non-transitory computer-readable device of claim 16, the operations further comprising:
in response to the receiving, scraping patent agency website information for a patent publication; and
updating the patentability model to incorporate a vectorized version of the patent publication.

21. The non-transitory computer-readable device of claim 16, wherein the patentability model includes a neural network.
